(19) United States
(12) Patent Application Publication
(10) Pub. No.: US 2020/0351156 A1
(43) Pub. Date: Nov. 5, 2020

(54) METHOD AND SYSTEM FOR FAST ONBOARDING NEW DEVICE INTO EXISTING IOT NETWORK

(71) Applicant: TP-Link Research America Corp., San Jose, CA (US)

(72) Inventors: Yajun Zhang, San Jose, CA (US); Mingyuan Li, San Jose, CA (US)

(73) Assignee: TP-Link Research America Corp.

(21) Appl. No.: 16/398,915

(22) Filed: Apr. 30, 2019

(51) Int. Cl. H04L 12/24; H04W 8/00; H04W 76/11; H04W 80/02; H04W 12/00; H04B 17/318

(52) U.S. Cl. CPC H04L 41/0806; H04W 8/005; H04B 17/318; H04W 80/02; H04W 12/0017; H04W 76/11

(57) ABSTRACT

A method of fast onboarding a new device to an existing network having one or more existing devices includes discovering one or more new devices by the one or more existing devices, selecting the new device from the discovered one or more new devices, selecting an existing device from the one or more existing devices to initiate an onboarding process for the selected new device, encoding configuration information for the new device to join the existing network, broadcasting the encoded configuration information, capturing the encoded configuration information by the new device. and join the new device into the existing network.

### FIELD

The present disclosure relates to wireless communication systems, and more particularly to systems and methods for automating an onboarding of a device to an existing network.

### BACKGROUND

The Internet of Things (IoT) is a system of interrelated devices and/or objects that are connected to the internet, collecting and sharing data. The onboarding process enables a new device and/or object to communicate with the devices/objects in an existing network (e.g., a Wi-Fi network) and the initial association of the new device/object with the existing network. The onboarding process generally includes an exchange of credential information to authorize the new device/object. For example, the onboarding process needs to ensure a user's newly purchased Internet-enabled smart light switch, correctly joins the user's existing home network, and not the neighbor's home network, and also only the user's devices are allowed to join the user's home network. With the rapid development of IoT technology and the gradual popularization of smart homes and smart communities, various smart terminal devices have emerged, such as smart plugs, smart light switches, smart light-bulbs, smart audios, smart cameras, smart refrigerators and so on. Many smart devices often do not come with a human-computer interaction interface or a user interface, and the onboarding has to rely on an external mobile application or a desktop application to configure with credentials entered manually (e.g., selecting network, entering password, etc.).

The stability and reliability of the complex onboarding process affect users' experiences with IoT devices and is an important measurement of the overall solution. Therefore, there is a need to develop simpler secure systems and methods to achieve a more user-friendly experience.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

The present disclosure will become more fully understood from the detailed description and the accompanying drawings.

FIG. 1 is a block diagram of an example IoT system for implementing a fast onboarding process according to the principles of the present disclosure.

FIG. 2 is a flowchart showing an example onboarding process according to the principles of the present disclosure.

FIG. 3 is a flowchart showing specific implementation for the example onboarding process of FIG. 2.

FIG. 4 is an example of service set identifier (SSID) design according to the principles of the present disclosure.

FIG. 5 is a block diagram showing an example hardware implementation for an onboardable device.

In the drawings, reference numbers may be reused to identify similar and/or identical elements.

### DETAILED DESCRIPTION

### Introduction

The present disclosure describes how to automatically fast onboard a new device onto a user specified existing network using a mobile computing device (e.g., a smartphone, a tablet, a laptop, a desktop computer, etc.). The existing network may be, for example, a Wi-Fi based IoT system, with one or more deployed existing devices. When a user acquires a new device to be added to the existing user's network, configuration information can be transmitted and shared securely and efficiently through wireless communications without manually changing the mobile computing device's settings. As of today, a common method of onboarding the new device onto an existing IoT network has been using software enabled Access Point (softAP) mode and Station Access (STA) mode through Wi-Fi.

With the softAP and STA configuration modes, the new device to be onboarded is set to softAP mode by default and a wireless Access Point (AP) is enabled. During onboarding process, the user can change the mobile computing devices' settings to actively scan and connect to the new device's wireless AP, then can transmit all necessary configuration information to the new device through a proprietary protocol. After obtaining valid configuration information, the new device switches to STA mode and join the specified existing network by associating itself with an AP or a wireless router specified in the configuration information. The user can then reconnect the mobile computing device back to the original network after the new device onboarding completes. Although such onboarding process is technically mature with low implementation risk, the user experience can be bad due to the long configuration process, the tedious implementation steps, and the repetitive setting switches required for the mobile computing device on which the management application is running. As such, a more user-friendly onboarding process is desired.

The present disclosure introduces an efficient system/method for the existing devices in the existing user's network to wirelessly and securely transmit configuration information to the new device without changing the settings of the mobile computing device on which the management application is running.

### Onboarding System and Method

A method of fast onboarding a new device to a selected existing network having one or more existing devices includes discovering one or more new devices by the one or more existing devices, selecting the new device from the discovered one or more new devices, selecting an existing device from the one or more existing devices to initiate an onboarding process for the selected new device, encoding configuration information for the new device to join the existing network, broadcasting the encoded configuration information, capturing the encoded configuration information by the new device and join the new device into the existing network.

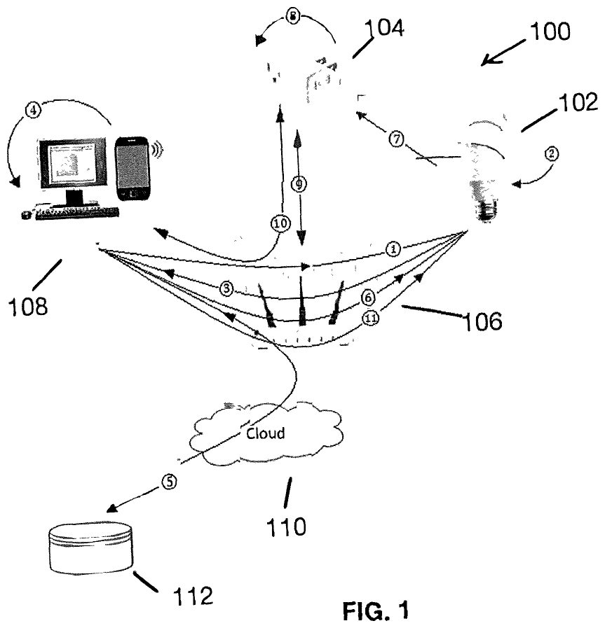

As shown by FIG. 1, a block diagram of an example IoT system 100 for implementing a fast onboarding process may include an existing device 102 (e.g., a smart bulb), a new device 104 (e.g., a smart plug) to be added to an existing network 106 including a wireless router 106, and a smart device 108 (e.g., a smartphone, a tablet, a computer, etc.). A management application may be running on the mobile computing device 108 for the user to manage the onboarding process so that the devices can communicate with each other directly and/or over the existing network 106. (1) Specifically, the user may send a command to the existing device 102 through the management application to instruct the existing device 102 to (2) start wireless scanning and to collect information of any available new device. The information collected by the existing device 102 may include, for example, Media Access Control (MAC) address, communication channels, signal strength, etc., and (3) may then be transmitted to the management application to be presented for the user's selection. (4) For example, the user can select and confirm the new device 104 to join the existing network by choosing one of the displayed MAC addresses. Alternatively, the user may be able to enter a piece of credential information associated with a new device. The credential information can be for example, a security code, a unique device ID, etc., which is associated and/or known by the new device (e.g., retrievable by the new device's self-contained flash memory, etc.). (5) Alternatively, the management application may obtain such credential information from a manufacture database 112 by passing, for example, a unique MAC address. The manufacture database 112 may be stored in the Cloud 110. (6) The management application may further send an acknowledge notice to the existing device 102 to inform that which new device is selected by the user for onboarding. The acknowledge notice may further include the credential information for the selected new device 104. (7) The existing device 102 may then create an AP interface to broadcast a designed Service Set Identifiers (SSIDs) that may include encoded configuration information specifically for the existing network 106. (8) The new device 104 may capture the designed SSIDs and may further decode the captured SSIDs to retrieve the configuration information. (9) The new device 104 may then use the configuration information to join the existing network 106. (10) Once the management application has detected that the new device 104 is onboarded, (11) it may inform the existing device 102 and may further instruct the existing device 102 to remove the AP interface and stop broadcasting the designed SSIDs.

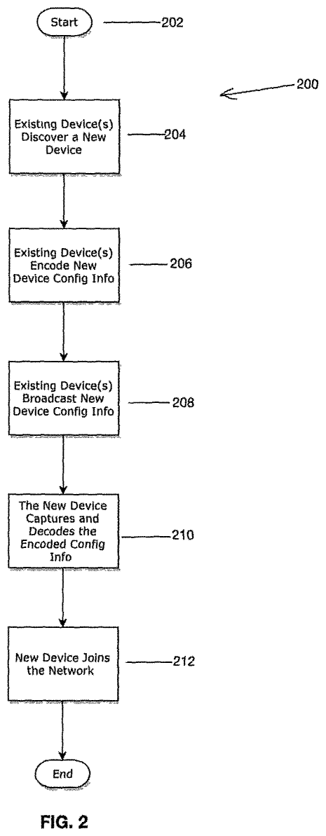

In FIG. 2, an example implementation process 200 of the system 100 is shown. The process begins at 202, where one or more existing devices 102 (e.g., a smart bulb) are installed in the existing network (e.g., a home Wi-Fi network), which generally requires an exchange of credential information to authenticate and authorize the new device.

At 204, the one or more existing devices 102 check whether there is any new device to be onboarded. For example, the user has purchased a new internet-enabled smart plug 104, and once the newly purchased smart plug 104 is powered on at the user's home, it needs to be identified by the existing installed smart bulb 102 in order to be onboarded and join the existing network 106. The already installed smart bulb 102 starts a background network scanning process to collect Wi-Fi network information such as SSID, MAC address, communication channel, signal strength, etc., from the new onboardable device(s) 104.

At 206, the smart bulb 102 encodes configuration information with a predetermined format specifically for the existing network 106, for example, a designed SSID.

At 208, the smart bulb 102 creates an AP interface to broadcast the designed SSID for the new onboarding device 104 to capture.

At 210, the new device 104 kicks off a background scanning process to capture the designed SSID and decodes the captured SSID to retrieve/obtain the configuration information. When scanning, the new device may lock the communication channel to fast capture the SSIDs.

At 212, the new device 104 configures on its own to join the existing network 106 using the obtained necessary configuration information. The new device 104 may register its information with a database in the Cloud 110 for remote control purpose. Additionally, and/or alternatively, some or all the configuration information can be retrieved from the Cloud database.

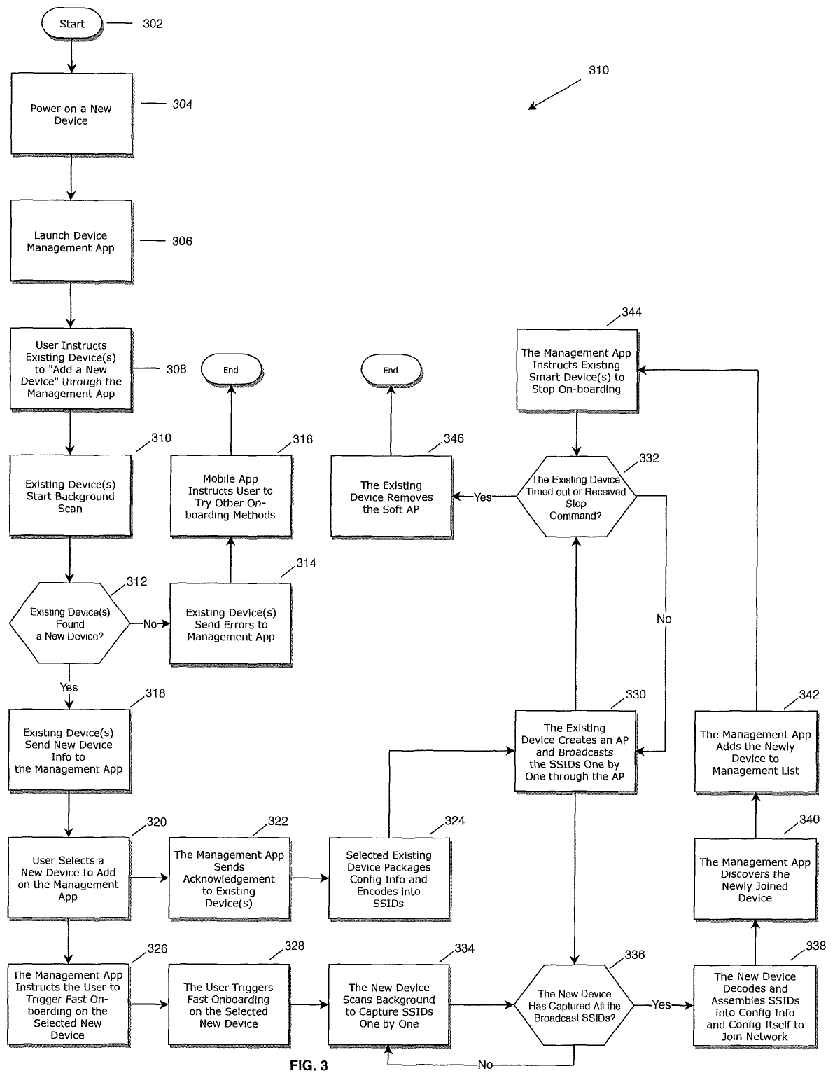

FIG. 3 illustrates a specific implementation process 300 for the example onboarding process of FIG. 2.

The process begins at 302 when the user has acquired a new device 104. At 304, the user powers on the new device and ensures the new device 104 is ready for onboarding.

At 306, the user launches the management application on the mobile computing device 108.

At 308, the user sends a command to the existing device 102 through the management application to instruct the one or more existing devices 102 to “add a new device.”

At 310, the one or more existing devices 102 start wireless scanning and collecting information of any available new devices upon receiving the command to “add a new device.” The information/data exchanges among the mobile computing device 108, the new device 104, and the one or more existing device 102 may use any one or more communication protocols, such as Transmission Control Protocol (TCP) and Internet Protocol (IP), User Datagram Protocol (UDP), Asynchronous Transfer mode (ATM), File Transfer Protocol (FTP), Hypertext Transfer Protocol (HTTP), or any remote Cloud-based relay or pass-through protocols, etc., regardless proprietary or public protocols.

At 312, the one or more existing devices 102 check whether a new device 104 has been discovered.

If No, at 314, the one or more existing devices 102 send errors to the management application, and at 316, the management application instructs the user to choose other onboarding method(s) (e.g., traditional onboarding methods, etc.).

If Yes, at 318, the existing one or more devices 102 reports to the management application all the found new devices and their information. The information collected by the one or more existing devices 102 may include, for example, Media Access Control (MAC) addresses, communication channels, signal strength, etc., which are then transmitted to the management application to be presented for the user's selection. For example, the mobile computing device 108 may include a user interface to display and list all the new devices and their information discovered and transmitted by the one or more existing devices 102.

At 320, the user selects a new device 104 from the found list to join the existing network 106 and acknowledges the selection to the management application. Specifically, the user can select the new device 104 by identifying a MAC address. Alternatively, in a situation when an out-of-band security solution is in use, the management application can request the user to enter a piece of credential information associated with or known to an onboarding new device. The credential information can be for example, a security code, a unique device ID (e.g., a device serial number that can uniquely identify the device, etc.), a HomeKit setup code, etc. Such credential information may be labeled on the new device, printed on the packaging of the new device, and/or retrievable from a flash memory that comes with the new device. Alternatively, the management application may obtain such credential information from a manufacture database 112 by passing the unique MAC address. The manufacture database 112 may be stored in the Cloud 110.

At 322, the management application sends an acknowledge notice to all the existing devices or one selected existing device (e.g., the one that is closest to the new device according to the signal strength collected at step 318, etc.) to inform which new device is selected by the user for onboarding. The acknowledgement notice may further include the credential information of the selected new device 104.

Upon receiving the acknowledge notice, at 324, the existing device 102 packages all the necessary configuration information and split the configuration information into multiple designed SSIDs with predetermined format for the new device 104 to capture and decode and then join the existing network 106.

Meanwhile at 326, the management application instructs the user to trigger the selected new device 104 for its fast onboarding mode. For example, at 328, the user can press a button for few seconds, or quickly turn on/off the device continuously for several times, etc. to invoke the fast onboarding mode of the new device 104. Instead of the foregoing mechanisms, one of ordinary skill will appreciate that any of many other mechanisms for triggering the fast onboarding may be implemented.

At 330, the existing device 102 creates an AP interface to broadcast the designed SSIDs one by one through the AP interface. Each SSID stays with the AP interface for a limited time (e.g., 50 milliseconds, 100 milliseconds, 200 milliseconds, etc.). The process of sending all the SSIDs through the AP interface is repeated until a preset timeout is reached or a stop command is received from the management application at 332.

At 334, the new device 104 scans background (e.g., active scan or passive scan) to capture the SSIDs one by one. Information extracted from the received SSIDs may include a prefix that serves as a header to identify the source of the SSID and a checksum for verifying the integrity of the received SSIDs. The prefix and the checksum can be used for the new device 104 to lock the communication channel for continuously scanning until all the designed SSIDs are captured.

At 336, checking to see if the new device 104 has captured all the broadcasted SSIDs. If No, at 334, the new device 104 keeps scanning to catch more SSIDs at 334. If Yes, at 338, the new device 104 decodes the captured SSIDs to retrieve the configuration information, assembles the retrieved configuration information based on the sequence number carried by the designed SSIDs, and uses the configuration information to join the existing network 106.

At 340, once the management application has detected that the new device 104 is onboarded, at 342, the management application adds the newly joined device 104 into a device management list. The new device 104 is now successfully onboarded.

Further at 344, the management application informs the existing device 102 that the new device 104 has been successfully onboarded and sends a command to the existing device 102 to stop the onboarding process scanning.

At 346, the existing device 102 removes the AP interface and stop broadcasting the designed SSIDs once received the stop command from the management application. In a situation the stop command is not successfully received, the existing device may remove the AP interface when a preset timeout is reached.

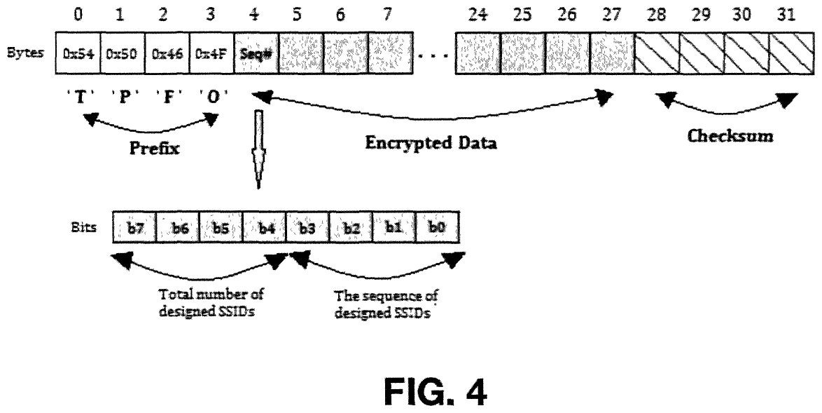

FIG. 4 illustrates an example of service set identifier (SSID) design to carry 24 bytes (a byte is 8 bits) information. The SSID (Service Set Identifier) is the name of a wireless network, which can be considered as part of the encryption algorithm. Using a specially designed SSID can make it difficult for a hacker to crack the encryption. The maximum length of an SSID is typically 32 bytes in the common industry practice, which can be supported by a Wi-Fi AP interface.

As shown in FIG. 4, the first 4 bytes (starting with the 0th byte on the left, ending on the 3rd byte on the left, i.e., bytes 0, 1, 2, 3) are used for a unique prefix, e.g., “TPFO”, representing TP-Link Fast Onboarding. This is unique to the existing network 106 and allows devices purchased from TP-Link to identify and connect.

Further, byte 4 can be designated to indicate SSIDs sequence information. For example, byte 4 (having 8 bits) can be divided into two parts, the high 4 bits are used to indicate the total number of designed SSIDs to carry information and the low 4 bits indicate the sequence orders of the current SSID among the total designed SSIDs. The 4 bits can specify up to 16 numbers. As such, the total of 16 SSIDs are designed to carry all the necessary configuration information with each SSID being assigned with a sequence order (e.g., 0th, 1st, 2nd, . . . , and 15th). Accordingly, the received SSIDs each carrying 1 of 16 pieces of configuration information can be re-assembled according to the sequences designated by the low 4 bits of byte 4 of the SSID.

Further, bytes 5 to 27 (total 23 bytes) may be designated to carry the specific configuration data for the new device 104. The specific configuration data is generally encrypted by using the credential information described above, for example, a setup code, a unique device ID, a MAC address, or any other predefined shared secret key, etc. The example shown here having 16 sequential SSIDs can carry up to 16×23 bytes (368 bytes), which is usually more than enough to contain configuration information needed for a typical IOT network. A typical configuration information required by an IOT network generally includes: a Wi-Fi network name, a password, a security and/or encryption mode, a cloud account name and password, and the new device name. Such information may take about 200 bytes. In a situation when the configuration information needs to take more than 368 bytes, each SSID can be designed to reserve 2 bytes (i.e., 16 bits) for SSID sequence information and 22 bytes for configuration data. With 16 bits to specify sequence information, the total number of SSIDs can be a lot more than 16. Thus, more configuration information can be carried by the SSIDs.

Lastly, bytes 28 to 31 (total 4 bytes) may be designed for a checksum that is encrypted with the same method used for bytes 5 to 27, as described above. The checksum is generally used for verifying the integrity of the received SSIDs. Specifically, the checksum is used to check the integrity of the configuration data carried in bytes 4 to 27. For example, there may be a situation when APs intended for networks other than the user specified existing network happen to have the same SSID prefix (e.g., “TPFO”), in which case the integrity check fails because of the information carried is not for the same new device 104. Accordingly, this unexpected SSID will be ignored.

Instead of the foregoing designs of SSIDs, one of ordinary skill will appreciate that any of many other designs for SSIDs may be implemented. For example, different arrangements/implementations of segments with/without prefix, encrypted configuration data, and checksum, etc. can be designed.

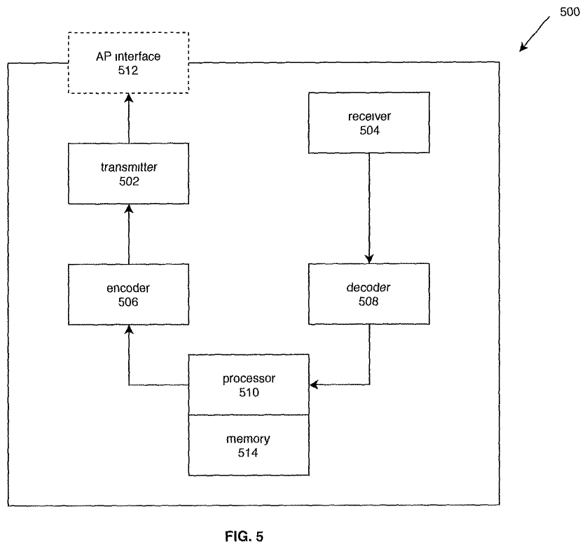

In FIG. 5, a block diagram illustrates an example hardware implementation for an onboardable device 500. The onboardable device 500 can be either the existing device 102 or the new device 104. The device 500 includes a transmitter 502 and a receiver 504 for transmitting and receiving information respectively. The device 500 may further include an encoder 506 and a decoder 508 respectively configured to encode and decode onboarding configuration information.

Specifically, before the device 500 joins the existing network, the receiver 504 is configured to capture/receive the encoded configuration information, the decoder 508 decodes the received information to retrieve the configuration information. A processor 510 contained in the device 500 is configured to automatically onboard the device 500 onto the existing network using the configuration information.

After the device 500 is onboarded and deployed in the existing network 106, it becomes an existing device 102. During the next device onboarding, the encoder 506 encodes the configuration information into one or more Service Set Identifiers (SSIDs) with a predetermined format. Each SSID may include a prefix and a sequence information section. The prefix is designed to identify the predetermined format of SSIDs for special configuration use and the sequence information section is designed to assemble the received information. The SSID may further include an encrypted section for ensure data security during communication. In addition, the SSID may further include a checksum for verifying the integrity of the received information.

The processor 510 is configured to create an AP interface to broadcast the encoded configuration information through the transmitter 502 for a new device to join the existing network 106. Further, the receiver 504 can be used to scan/receive identifiable information of any available new devices in the area around the device 500. Furthermore, the receiver 504 is capable of receiving instructions from the management application running in the mobile computing device. For example, the management application may instruct the device 500 that the onboarding process is completed for the new device and instruct the device 500 to remove the AP interface and stop broadcasting the encoded configuration information.

The identifiable information that is associated with and is used to identify the new device to be onboarded. The identifiable information may include a security code and/or a unique device ID.

The device 500 further includes a memory 514 to store the identifiable information. Additionally, the identifiable information may be registered with a manufacture database. The manufacture database is stored in the Cloud.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method of fast onboarding a new device to an existing network having one or more existing devices, the method comprising:
discovering one or more new devices by the one or more existing devices;
selecting the new device from the discovered one or more new devices;
selecting an existing device from the one or more existing devices to initiate an onboarding process for the selected new device;
encoding configuration information for the new device to join the existing network;
broadcasting the encoded configuration information;
capturing the encoded configuration information by the new device; and
join the new device into the existing network.

2. The method of claim 1, wherein discovering the new device by the one or more existing devices includes wireless scanning and collecting information of the new device.

3. The method of claim 2, wherein the collecting information of the new device includes collecting one or more of the following information:
a Media Access Control (MAC) address,
a communication channel, and
a signal strength.

4. The method of claim 3, wherein selecting the new device from the discovered one or more new devices is based on the collected information.

5. The method of claim 1, wherein selecting the new device from the discovered one or more new devices is based on the MAC address.

6. The method of claim 1, wherein encoding configuration information includes encoding the configuration information into one or more Service Set Identifiers (SSIDs) with a predetermined format.

7. The method of claim 6, wherein each of the one or more SSIDs includes one or more of the following information:
a prefix,
an encrypted section, and
a checksum.

8. The method of claim 7, wherein the encrypted section is encrypted by using at least one of: a setup code, a security code, a unique device ID, a MAC address, and a predefined shared secret key.

9. The method of claim 8, further comprising:
decoding the configuration information to retrieve the configuration information for the new device to join the existing network automatically.

10. The method of claim 1, wherein broadcasting the encoded configuration information further comprising creating a wireless Access Point (AP) interface for broadcasting the encoded configuration information.

11. The method of claim 10, further comprising:
removing the AP interface and stop broadcasting the encoded configuration information once the new device has joined the existing network.

12. A device comprising:
a transmitter configured to transmit information;
a receiver configured to receive information or instructions;
an encoder configured to encode configuration information into one or more Service Set Identifiers (SSIDs) with a predetermined format, each SSID including a prefix and a sequence information section, wherein the prefix is designed to identify the predetermined format and the sequence information section is designed to assemble the received information;
a decoder to decode the encoded configuration information to retrieve the configuration information;
a processor configured to create and remove an AP interface, the AP interface being used for broadcasting the encoded configuration information through the transmitter; and
a processor configured to automatically join a selected network using the configuration information.

13. The device of claim 12, wherein the SSID is further includes an encrypted section to ensure data security during communication.

14. The device of claim 13, wherein the encrypted section is encrypted by using at least one of: a setup code, a security code, a unique device ID, a MAC address, and a predefined shared secret key.

15. The device of claim 12, wherein the SSID further includes a checksum for verifying an integrity of the received information.

16. The device of claim 12, further comprising identifiable information that is associated with the device and is used to identify the device.

17. The device of claim 16, wherein the identifiable information includes at least one of a security code and a unique device ID.

18. The device of claim 16, further comprising a memory for storing the identifiable information.

19. The device of claim 16, wherein the identifiable information is registered with a manufacture database.

20. The device of claim 19, wherein the manufacture database is stored in the Cloud.
